(19) United States
(12) Patent Application Publication
(10) Pub. No.: US 2008/0108749 A1
(43) Pub. Date: May 8, 2008

(54) Fluoropolymer nanoemulsions

(75) Inventor: Wei Chen, Singapore (SG)

Correspondence Address: WEI CHEN, 86 MARINE PARADE CENTRAL, #03-210, SINGAPORE, 440086, omitted

(73) Assignee: NANOMAX TECHNOLOGY COMPANY LIMITED

(21) Appl. No.: 11/593,862

(22) Filed: Nov. 7, 2006

(51) Int. Cl. C08K 5/02

(52) U.S. Cl. 524/795

(57) ABSTRACT

This invention teaches novel fluoropolymer nanoemulsion products and process. The fluoropolymer nanoemulsions comprise at least 20% by weight of colloidal fluoropolymer nano-particles with average diameter in the range of 1 to 150 nanometer, 0.1% to 3.0% by weight of halogenated dispersing agents selected from fluoro surfactants, chlorofluoro surfactants, hydrofluoro surfactants, or hydrochlorofluoro surfactants, and any CFC (chlorofluorocarbon) or HFC (hydrofluorocarbon) or any HCFC (hydrochlorofluorocarbon) or any CC (chlorocarbon) was mostly removed from the nanoemulsion to be less than 0.5% by weight of the nanoemulsion.

### FIELD OF THE INVENTION

This invention relates to novel fluoropolymer polymerization process, which results in environmentally-friendly aqueous nanoemulsions containing colloidal nano-particles of fluoropolymers that have unique applications in many industries.

### BACKGROUND OF THE INVENTION

Fluoropolymers are unique high value polymers that have for examples higher temperature and better chemical resistant properties than many other polymers. Here nano-particles are defined as particles with average particle size between 1 and 15 nanometer. Much smaller than conventional micrometer size particles, nano-particles have order of magnitude larger in surface area which can cost-effectively maximize the unique surface property of fluoropolymers as well as more uniform distribution of fluoropolymers in many applications.

Conventional fluoropolymers have been made by dispersion polymerization process with fluorinated monomers (fluoromonomers) being polymerized in aqueous solution containing a surfactant (dispersant). The most commonly used surfactant in fluoropolymer industry has been perfluoro octanoic acid ammonium salt (C8). However, US environmental protection agency has issued a warning about C8, which has now been recognized as potential human carcinogen. More than 95% of Americans have been found their body contaminated by C8 in their blood. All major fluoropolymer manufacturers have agreed to have C8 phased out by 2016. This prompts global search for new environmentally-friendly low-toxicity surfactants that can be used to produce similar or superior fluoropolymers.

Processes for making colloidal nano-particles of fluoropolymers have been disclosed. For examples, in U.S. Pat. Nos. 4,789,717 and 4,864,006, Giannetti et al. teach the use of fluorinated surfactants, characterized in that it is operated in the presence of a perfluoropolyether having neutral end groups and prepared in the form of an aqueous microemulsion. However, the suggested fluorinated surfactants and perfluoropolyether having neutral end group are very expensive and difficult to be removed from the products and difficult to be decomposed by the environment. Similar teaching also has also been presented in U.S. Pat. No. 6,297,334 with similar ingredients, which present the same problems. In U.S. Pat. No. 6,429,258, Morgan et al. teach the use of a combination of fluorosurfactants, one of which is a perfluoropolyether carboxylic acid or salt. The said perfluoropolyether carboxylic acid or salt are of high molecular weight, very expensive, difficult to be removed from the products and difficult to be decomposed by the environment. In U.S. Pat. No. 5,880,213, No. 5,895,799, No. 6,037,399, No. 6,046,271, and No. 6,156,839, Wu et al. teach the use of microemulsion containing liquid perfluorinated hydrocarbon having a molecular weight below 500 selected from the class consisting of perfluorinated aromatic compound and a heterocyclic aliphatic compound containing oxygen or sulfur in the ring. Similar problems to other prior arts, these perfluorinated hydrocarbons are very expensive, difficult to be removed from the products and difficult to be decomposed by the environment.

It is the purpose of this invention to utilize novel environmentally-friendly process and ingredients to produce superior fluoropolymer nanoemulsions.

### SUMMARY OF THE INVENTION

This invention provides a novel process that enables producing fluoropolymer aqueous nanoemulsions, consisting of colloidal fluoropolymer nano-particles with average diameter in the range of 1 to 150 nanometers. The fluoropolymer content of the nanoemulsions is greater than 20% by weight, preferably greater than 30% by weight, most preferably greater than 40% by weight.

The said novel process comprises

(1) polymerizing at least one fluorinated monomer in an aqueous medium containing initiator and dispersing agent, characterized in that it is operated in the presence of at least a CFC (chlorofluorocarbon) or a HFC (hydrofluorocarbon) or a HCFC (hydrochlorofluorocarbon) or a CC (chlorocarbon) with average molecular weight less than 500, wherein at least a microemulsion phase is present; and optionally

(2) Removing partially or mostly the said CFC (chlorofluorocarbon) or a HFC (hydrofluorocarbon) or a HCFC (hydrochlorofluorocarbon) or a CC (chlorocarbon) from the resulting fluoropolymer nanoemulsions by a separation process such as distillation or vacuum distillation or extraction.

Preferably, the said CFC (chlorofluorocarbon) or a HFC (hydrofluorocarbon) or HCFC (hydrochlorofluorocarbon) or CC (chlorocarbon) have normal boiling point less than 180° C., so that they can be easily removed by distillation or vacuum distillation from fluoropolymer nanoemulsions. CFC, HFC, HCFC, and CC not only have much lower cost than perfluorinated liquids mentioned in all the prior arts but also have lower solubility in fluoropolymers, which makes it easier to be separated from fluoropolymers and to maintain original fluoropolymer properties.

In another preferred embodiment, the dispersing agents are fluoro surfactants, chlorofluoro surfactants, hydrofluoro surfactants, or hydrochlorofluoro surfactants. In order to form a stable microemulsion phase with (CFC, HFC, HCFC, or CC), chlorofluoro surfactants or hydrofluoro surfactants or hydrochlorofluoro surfactants are preferred. Perfluoro surfactants are usually not friendly to human body, as they tend to have high retention time accumulated in human body. This is due to the fact that perfluoro surfactants like C8 can fool human kidney that it is a good nutrient to keep. Unlike perfluoro surfactants, chlorofluoro surfactants, hydrofluoro surfactant, or hydrochlorofluoro surfactants are expected to have much shorter shelf life in human body.

In another preferred embodiment, the dispersing agents are fluoropolyether carboxylic acids and salts, chlorofluoropolyether carboxylic acids and salts, hydrofluoropolyether carboxylic acids and salts, or hydrochlorofluoropolyether carboxylic acids and salts. The dispersing agents have average molecular weight between 200 and 1800 and each molecule contains one or two carboxylic acid groups.

In its second embodiment of this invention, it discloses fluoropolymer nanoemulsions comprising at least 20% by weight of colloidal fluoropolymer nano-particles with average diameter in the range of 1 to 150 nanometer, 0.1% to 3.0% by weight of halogenated dispersing agents selected from fluoro surfactants, chlorofluoro surfactants, hydrofluoro surfactants, or hydrochlorofluoro surfactants, and 0.1% to 3.0% by weight of at least a CFC (chlorofluorocarbon) or a HFC (hydrofluorocarbon) or a HCFC (hydrochlorofluorocarbon) or a CC (chlorocarbon) with average molecular weight less than 500.

In its third embodiment of this invention, it discloses fluoropolymer nanoemulsions comprising at least 20% by weight of colloidal fluoropolymer nano-particles with average diameter in the range of 1 to 150 nanometer, 0.1% to 3.0% by weight of halogenated dispersing agents selected from fluoro surfactants, chlorofluoro surfactants, hydrofluoro surfactants, or hydrochlorofluoro surfactants, and any CFC (chlorofluorocarbon) or any HFC (hydrofluorocarbon) or any HCFC (hydrochlorofluorocarbon) or any CC (chlorocarbon) having been partially or mostly removed from the nanoemulsion to be less than 0.5%, preferably less than 0.2% by weight of the nanoemulsion.

### DETAILED DESCRIPTION OF THE INVENTION

This invention provides a novel process that enables producing fluoropolymer aqueous nanoemulsions, consisting of colloidal fluoropolymer nano-particles with average diameter in the range of 1 to 150 nanometers. The fluoropolymer content of the nanoemulsions is greater than 20% by weight, preferably greater than 30% by weight, most preferably greater than 40% by weight.

The said novel process comprises

(1) polymerizing at least one fluorinated monomer in an aqueous medium containing initiator and dispersing agent, characterized in that it is operated in the presence of at least a CFC (chlorofluorocarbon) or a HFC (hydrofluorocarbon) or a HCFC (hydrochlorofluorocarbon) or a CC (chlorocarbon) with average molecular weight less than 500, wherein at least a microemulsion phase is present; and optionally

(2) Removing partially or mostly the said CFC (chlorofluorocarbon) or a HFC (hydrofluorocarbon) or a HCFC (hydrochlorofluorocarbon) or a CC (chlorocarbon) from the resulting fluoropolymer nanoemulsions by a separation process such as distillation or vacuum distillation or extraction.

Preferably, the said CFC (chlorofluorocarbon) or a HFC (hydrofluorocarbon) or HCFC (hydrochlorofluorocarbon) or CC (chlorocarbon) have normal boiling point less than 180° C., so that they can be easily removed by distillation or vacuum distillation from fluoropolymer nanoemulsions. The use of CFC, HFC, HCFC, or CC are novel over perfluorinated fluids taught in the prior arts, because our suggested fluids are not only lower in cost but also have lower solubility in fluoropolymers resulting in easier removal of such fluid from nanoemulsion and not affecting fluoropolymer's original property. Even if there may be some chain transfer reaction occurs, our suggested molecules can actually end cap fluoropolymer end groups to improve their thermal property further. Because of potential chain transfer reaction during fluoropolymer polymerization with our suggested fluids, one would expect slower reaction rate than the use of perfluorinated fluids. Surprisingly, on the contrary, equal or faster polymerization rates have been observed with the use of some of our suggested fluids than the use of perfluorinated fluids taught in the prior arts.

Good examples of the said CFC (chlorofluorocarbon) or HCFC (hydrochlorofluorocarbon) or CC (chlorocarbon) include but not limited to those refrigerants such as R-10 (CCl₄), R-11 (CCl₃F), R-12 (CCl₂F₂), R-21 (CHCl₂F), R-31 (CH₂ClF), R-111 (CCl₃CCl₂F), R-112 (CCl₂FCCl₂F), R-112a (CCl₃CClF₂), R-113 (CCl₂FCClF₂), R-113a (CCl₃CF₃), R-114 (CClF₂CClF₂), R-114a (CF₃CFCl₂), R-121 (CCl₂FCHCl₂), R-121a (CHClFCCl₃), R-122 (CClF₂CHCl₂), R-122a (CHClFCCl₂F), R-123 (CF₃CHCl₂), R-123a (CClF₂CHClF), R-124 (CF₃CHClF), R-124a (CHF₂CFCl₂), R-131 (CHClFCHCl2), R-131a (CH₂ClCCl₂F), R-132 (CHClFCHClF), R-132a (CHCl₂CHF₂), R-132b (CH₂ClCClF₂), R-132c (CCl₂FCH₂F), R-133 (CHClFCHF₂), R-133a (CF₃CH₂Cl), R-133b (CClF₂CH₂F), R-141 (CHCl₂CHClF), R-141a (CHCl₂CH₂F), R-141b (CCl₂FCH₃), R-142 (CHF₂CH₂Cl), R-142a (CHClFCH₂F), R-142b (CClF₂CH₃), R-151 (CH₂FCH₂Cl), R-151a (CH₃CHClF), R-152 (CH₂FCH₂F), R-214cb (CCl₃CF₂CF₂Cl), R-215a (CF₃CCl₂CClF₂), R-216ba (CF₃CClFCF₂Cl), R-217ba (CF₃CFClCF₃), R-224db (CF₃CHClCCl₂F), R-225ba (CF₃CClFCHClF), R-225ca (CF₃CF₂CHCl₂), R-225cb (CF₂ClCF₂CHClF), R-225cc (CHF₂CF₂CFCl₂), R-225da (CF₃CHClCClF₂), R-226da (CF₃CHClCF₃), R-226ea (CF₃CHFCF₂Cl), R-234da (CF₃CHClCHClF), R-235ca (CF₃CF₂CH₂Cl), R-235fa (CF₃CH₂CF₂Cl), R-236ea (CF₃CHFCHF₂), R-243db (CF₃CHClCH₂Cl), R-244ca (CHF₂CF₂CH₂Cl), R-245ca (CHF₂CF₂CH₂F), R-245fa (CF₃CH₂CHF₂), R-254fb (CF₃CH₂CH₂F), R314 (1,1,2,2-tetrachlorotetrafluorocyclobutane), Trichlorohexafluorobutane, R3161bb (1,2,3,4-tetrachlorohexafluorobutane), R316maa (2,2,3,3-tetrachlorohexafluorobutane), R-317mab (CF₃CCl₂CClFCF₃), 1,1,1,3,3-Pentafluorobutane, Octafluorobutane, 1,2,2,2-Tetrafluoroethyl difluoromethyl ether, 3,3,4,4-Tetrafluorohydrofuran, 1,1,2,3,3,3-Hexafluoropropyl difluoromethyl ether, 1,1,2,3,3,3-Hexafluoropropyl trichloromethyl ether, 1,1,2,3,3,3-Hexafluoropropyl 2,2,2-trifluoroethyl ether, 1H,1H,2H-Heptafluorocyclopentane, 1H,2H-Octafluorocyclopentane, 2H,3H-Perfluoropentane, Nonafluoropentane, 1,1,3,5,6-Pentachloroperfluorohexane, 1H-Perfluorohexane, 1H,6H-Dodecafluorohexane, 1H-Perfluoroheptane, 1H,1H,5H-Octafluoropentyl 1,1,2,2-tetrafluoroethyl ether, 1H,8H-Perfluorooctane, 1H-Perfluorooctane, 1H,1H,2′H-Perfluorodipropyl ether, 1-Chloro-2,2,2-trifluoroethyl difluoromethyl ether, 2,2,2-Trifluoroethyl trifluoroacetate, et al.

In another preferred embodiment, the dispersing agents are fluoro surfactants, chlorofluoro surfactants, hydrofluoro surfactant, or hydrochlorofluoro surfactants. Good examples include but not limited to the following: perfluoroalkyl ethane sulfonic acids and salts disclosed by Khan & Morgan in U.S. Pat. No. 4,380,618, Blaise & Grimaud in U. S. Pat. No. 4,025,709 and Baker & Zipfel in U.S. Pat. Nos. 5,688,884 and 5,789,508; the perfluoroalkoxy benzene sulfonic acids and salts disclosed by Morgan in U.S. Pat. No. 4,621,116; the partially-fluorinated carboxylic acids and salts disclosed by Feiring et al. in U.S. Pat. No. 5,763,552; the perfluoropolyether carboxylic acids and salts disclosed by Garrison in U.S. Pat. No. 3,271,341, Giannetti & Visca in U.S. Pat. No. 4,864,006, and Abusleme & Maccone in European Patent Application Publication 0625,526. Microemulsions are defined as a clear liquid phase which forms spontaneously upon mixing of all ingredients favored by thermodynamic potential. In order to form a stable microemulsion phase with CFC, HFC, HCFC, or CC, chlorofluoro surfactants or hydrofluoro surfactants or hydrochlorofluoro surfactants are preferred. Perfluoro surfactants are usually not friendly to human body, as they tend to have high retention time accumulated in human body. This is due to the fact that perfluoro surfactants like C8 can fool human kidney that it is a good nutrient to keep. Unlike perfluoro surfactants, chlorofluoro surfactants, hydrofluoro surfactant, or hydrochlorofluoro surfactants are expected to have much shorter shelf life in human body. In another preferred embodiment, the dispersing agents are fluoropolyether carboxylic acids and salts, chlorofluoropolyether carboxylic acids and salts, hydrofluoropolyether carboxylic acids and salts, or hydrochlorofluoropolyether carboxylic acids and salts. The dispersing agents have average molecular weight between 200 and 1800 and each molecule contains one or two carboxylic acid groups. These halogenated polyethers have been well taught in literature, such as several U.S. patents issued to Exfluor Research Corporation (Austin, Tex., USA) utilizing liquid phase fluorination process and many others in U.S. Pat. No. 3,242,218, No. 3,665,041, No. 4,451,646, No. 4,523,039, No. 4,859,299, and European Patent No. 148,482. Commercial fluoropolyether suppliers also include DuPont Krytox® brand, Solvay Fomblin® Fluorolink® brand, Daikin Demnum® brand. Fluorinated monomers means monomers capable of being radical polymerized and containing at least 35 weight % fluorine and having 2-18 carbon atoms. Examples of fluorinated monomers include but not limited to tetrafluoroethylene (TFE), vinyl fluoride (VF), vinylidene fluoride (VF₂), trifluoroethylene, hexafluoropropylene (HFP), chlorotrifluoroethylene (CTFE), fluoro(alkyl vinyl ether), such as perfluoro(propyl vinyl ether), perfluoro(ethyl vinyl ether), and perfluoro(methyl vinyl ether), fluoro(alkoxy vinyl ether), fluoroalkyl ethylene, fluoroalkoxy ethylene, fluoroalkyl acrylates, fluoroalkyl methacrylates and the like.

The fluorinated monomers may be polymerized alone to form a homopolymer if the monomer can be homopolymerized, or may be polymerized with one or more other fluorinated monomers or non-fluorinated monomers to form copolymers. Non-fluorinated monomers include hydrogenated monomers, such as ethylene, propylene, isobutylene, butylenes, and the like. Examples of useful homopolymers include polytetrafluoroethylene (PTFE), polychlorotrifluoroethylene (PCTFE), polyvinyl fluoride (PVF) and polyvinylidene fluoride (PVDF). Also usually classed with homopolymer PTFE are the modified PTFE polymers containing monomers other than TFE in such small amount that the modified polymers retain the non-melt-fabricable character of PTFE. Examples of useful copolymers could be made by copolymerization of combination of the above mentioned monomers, which are capable of being copolymerized. The copolymers can be thermoplastic or elastomeric. They can be amorphous or partially crystalline, melt-fabricable or non-melt-fabricable. A minor amount of cure site monomer can also be included in the copolymers. Examples of cure site monomers include but not limited to bromofluoroalkoxyethylene, bromotetrafluorobutene, CF₂═CF[OCF₂CFCF₃]ₘ—O—(CF₂)ₙ—CH₂OH as disclosed in U.S. Pat. No. 5,310,838, and CF₂═CF[OCF₂CFCF₃]ₘ—O—(CF₂)ₙ—CH₂COOH as disclosed in U.S. Pat. No. 4,138,426, and others containing different functional end group such as —SO₂F, —CN, —OCN, —O—(CO)—NH₂ or —OP(O)(OH)₂.

Initiator means inorganic or organic chemicals that can generate free radical between 0 and 150° C. Good examples of inorganic initiators include ammonium persulfate, sodium persulfate, potassium persulfate, potassium permanganate, and the like. Examples of organic initiators include organic peroxides such as tert-butyl peroxide and hydrogen peroxide, azo compounds such as AIBN, and the like. Polymerization pressure can be from 1 to 100 atmospheres, preferably between 1 and 50 atmospheres, most preferably between 1 and 30 atmospheres.

The fluoropolymer nano-particles have average colloidal particle diameter preferably between 1 and 130 nanometers, most preferably between 10 and 100 nanometers.

In its second embodiment of this invention, it discloses fluoropolymer nanoemulsions comprising at least 20% by weight of colloidal fluoropolymer nano-particles with average diameter in the range of 1 to 150 nanometer, 0.1% to 3.0% by weight of halogenated dispersing agents selected from fluoro surfactants, chlorofluoro surfactants, hydrofluoro surfactants, or hydrochlorofluoro surfactants, and 0.1% to 3.0% by weight of at least a CFC (chlorofluorocarbon) or a HFC (hydrofluorocarbon) or a HCFC (hydrochlorofluorocarbon) or a CC (chlorocarbon) with average molecular weight less than 500.

In its third embodiment of this invention, it discloses fluoropolymer nanoemulsions comprising at least 20% by weight of colloidal fluoropolymer nano-particles with average diameter in the range of 1 to 150 nanometer, 0.1% to 3.0% by weight of halogenated dispersing agents selected from fluoro surfactants, chlorofluoro surfactants, hydrofluoro surfactants, or hydrochlorofluoro surfactants, and any CFC (chlorofluorocarbon) or any HCFC (hydrochlorofluorocarbon) or any CC (chlorocarbon) having been partially or mostly removed from the nanoemulsion to be less than 0.5%, preferably less than 0.2% by weight of the nanoemulsion.

### Test Methods

Acid value: For each gram of halogenated carboxylic acid surfactant, the amount of sodium hydroxide in milligram is used to neutralize the acid surfactant to pH about 7 is called the acid value. The acid value is determined by adding one gram of acid surfactant in 100 ml of ethanol aqueous solution (50% by weight of ethanol), following by acid-base titration with 1 N sodium hydroxide solution till neutralization (pH about 7). The amount of sodium hydroxide in milligram used is obtained as the acid value for the acid surfactant.

### EXAMPLES

The following examples shall not limit the entire scope of this invention. The dispersing agents used in all examples are characterized as a mixture of fluoropolyether carboxylic acids ammonium salts, wherein the fluoropolyether carboxylic acids contains 0-30% by weight of chlorine and 0-6% by weight of hydrogen. Each fluoropolyether carboxylic acid molecule has molecular weight between 200 and 1800 and each molecule contains one or two carboxylic acid groups, while more than 30% of the fluoropolyether carboxylic acids contain only one carboxylic acid group.

### Example 1

20 gram of the said fluoropolyether carboxylic acids with average acid number of 88 (mg of NaOH/g of acid) were neutralized by ammonia (30% in water) with some additional de-ionized water to make up 20% of the said fluoropolyether carboxylic acid ammonium solution in water. The entire surfactant solution was added to a 5-liter autoclave reactor equipped with a mechanical stirrer. Additional 2000 ml of de-ionized water was also added to the autoclave. The autoclave was then sealed and under vacuum to about 10 mm Hg. The autoclave was then filled with tetrafluoroethylene (TFE) to about 2 kg/cm² and then under vacuum again to about 10 mm Hg. The procedure was repeated until the oxygen content in the autoclave was less than 25 ppm.

While the autoclave was under vacuum, 10 gram of R-113 (CCl₂FCClF₂), a chlorofluorocarbon, was introduced into the autoclave. Then, the dispersion in the autoclave was heated to about 95° C. A microemulsion phase was formed. Then, the autoclave was brought to about 20 kg/cm² using a gaseous mixture, containing about 60% by moles of hexafluoropropylene (HFP) and 40% by moles of TFE. Then, 3 gram of ammonium persulfate dissolved in 200 ml of de-ionized water was introduced to the autoclave. As soon as the pressure in the autoclave began to decrease, it was restored by feeding a gaseous HFP/TFE mixture containing about 7% by moles of HFP. The pressure inside the autoclave was kept at about 20 kg/cm² and temperature at about 95° C. for about 1 hour of reaction. The reaction was stopped by lowering the autoclave temperature to room temperature and the gas mixture was discharged. The dispersion was under vacuum at about 10 mm Hg for 15 minutes in order to have most R-113 (CCl₂FCClF₂) removed from the dispersion product. Later, a clear transparent fluoropolymer nanoemulsion containing about 22% by weight of a fluoropolymeric resin was obtained. The fluoropolymer nanoemulsion was found to be colloidal stable, as little coagulant was found.

The average diameter of the fluoropolymer nano-particles was found to be about 30 to 50 nanometers by electron microscopy. The fluoropolymer has distinct melting curve from 250 to 280° C. by DSC (Differential Scan Calorimeter) similar to commercial FEP polymer.

### Comparative Example 1

Example 1 was repeated except that R-113 (CCl₂FCClF₂) was replaced by Fluorinert® FC-75, an expensive perfluorocarbon fluid from 3M. To our surprise, the use of perfluorocarbon did not increase polymerization rate as compared to Example 1. On the contrary, the resulting fluoropolymer nanoemulsion was less colloidal stable than Example 1, as some coagulant was found in a few weeks.

### Example 2

20 gram of the said fluoropolyether carboxylic acids with average acid number of 76 (mg of NaOH/g of acid) were neutralized by ammonia (30% in water) with some additional de-ionized water to make up 20% of the said fluoropolyether carboxylic acid ammonium solution in water. The entire surfactant solution was added to a 5-liter autoclave reactor equipped with a mechanical stirrer. Additional 2000 ml of de-ionized water was also added to the autoclave. The autoclave was then sealed and under vacuum to about 10 mm Hg. The autoclave was then filled with tetrafluoroethylene (TFE) to about 2 kg/cm² and then under vacuum again to about 10 mm Hg. The procedure was repeated until the oxygen content in the autoclave was less than 25 ppm.

While the autoclave was under vacuum, 20 gram of R-225da (CF₃CHClCClF₂), a hydrochlorofluorocarbon, was introduced into the autoclave. 5 gram of a monomer called perfluoro(propyl vinyl ether) was then introduced to the autoclave. The dispersion in the autoclave was heated to about 80° C. A microemulsion phase was formed. Then, the autoclave was brought to about 20 kg/cm² using gaseous TFE. Then, 2 gram of ammonium persulfate dissolved in 200 ml of de-ionized water was introduced to the autoclave. As soon as the pressure in the autoclave began to decrease, it was restored by feeding gaseous TFE. The pressure inside the autoclave was kept at about 20 kg/cm² and temperature at about 80° C. for about 1 hour of reaction. The reaction was stopped by lowering the autoclave temperature to room temperature and the TFE gas was discharged. The dispersion was under vacuum at about 10 mm Hg for 15 minutes in order to have R-225da (CF₃CHClCClF₂) removed from the product. Later, a transparent fluoropolymer nanoemulsion containing about 24% by weight of a fluoropolymeric resin was obtained. The fluoropolymer nanoemulsion was found to be colloidal stable.

The average diameter of the fluoropolymer nano-particles was found to be about 40 to 70 nanometers by electron microscopy. The fluoropolymer has distinct melting curve from 320 to 335° C. by DSC (Differential Scan Calorimeter) characterized as modified PTFE polymer.

### Comparative Example 2

Example 2 was repeated except that R-225da (CF₃CHClCClF₂) was replaced by perfluorohexane, an expensive perfluorocarbon. To our surprise, the use of perfluorohexane did not increase polymerization rate as compared to Example 2. On the contrary, the resulting fluoropolymer nanoemulsion was less colloidal stable than Example 2, as some coagulant was found in a few weeks.

### Example 3

20 gram of the said fluoropolyether carboxylic acids with average acid number of 68 (mg of NaOH/g of acid) were neutralized by ammonia (30% in water) with some additional de-ionized water to make up 20% of the said fluoropolyether carboxylic acid ammonium solution in water. The entire surfactant solution was added to a 5-liter autoclave reactor equipped with a mechanical stirrer. Additional 2000 ml of de-ionized water was also added to the autoclave. The autoclave was then sealed and under vacuum to about 10 mm Hg. The autoclave was then filled with chlorotrifluoroethylene (CTFE) to about 2 kg/cm² and then under vacuum again to about 10 mm Hg. The procedure was repeated until the oxygen content in the autoclave was less than 25 ppm.

While the autoclave was under vacuum, 15 gram of R-123a (CClF₂CHClF), a hydrochlorofluorocarbon, was introduced into the autoclave. The dispersion in the autoclave was heated to about 70° C. A microemulsion phase was formed. Then, the autoclave was brought to about 16 kg/cm² using gaseous CTFE. Then, 3 gram of ammonium persulfate dissolved in 200 ml of de-ionized water was introduced to the autoclave. As soon as the pressure in the autoclave began to decrease, it was restored by feeding gaseous CTFE. The pressure inside the autoclave was kept at about 16 kg/cm² and temperature at about 70° C. for about 3 hour of reaction. The reaction was stopped by lowering the autoclave temperature to room temperature and the CTFE gas was discharged. The dispersion was under vacuum at about 10 mm Hg for 15 minutes in order to have R-123a (CClF₂CHClF) removed from the product. Later, a translucent white fluoropolymer nanoemulsion containing about 25% by weight of a fluoropolymeric resin was obtained. The fluoropolymer nanoemulsion was found to be colloidal stable.

The average diameter of the fluoropolymer nano-particles was found to be about 60 to 110 nanometers by electron microscopy.

### Comparative Example 3

Example 3 was repeated except that R-123a (CClF₂CHClF) was replaced by Galden® HT-135, an expensive perfluoropolyether having neutral end groups from Solvay. To our surprise, the use of perfluoropolyether did not increase polymerization rate as compared to Example 3. On the contrary, the resulting fluoropolymer nanoemulsion was less colloidal stable than Example 3, as some coagulant was found in a few weeks.

### Example 4

20 gram of the said fluoropolyether carboxylic acids with average acid number of 72 (mg of NaOH/g of acid) were neutralized by ammonia (30% in water) with some additional de-ionized water to make up 20% of the said fluoropolyether carboxylic acid ammonium solution in water. The entire surfactant solution was added to a 5-liter autoclave reactor equipped with a mechanical stirrer. Additional 2000 ml of de-ionized water was also added to the autoclave. The autoclave was then sealed and under vacuum to about 10 mm Hg. The autoclave was then filled with vinylidene fluoride (VF₂) to about 2 kg/cm² and then under vacuum again to about 10 mm Hg. The procedure was repeated until the oxygen content in the autoclave was less than 25 ppm.

While the autoclave was under vacuum, 10 gram of 2H,3H-perfluoropentane (a hydrofluorocarbon) and 5 gram of R-10 (CCl₄), a chlorocarbon, was introduced into the autoclave. Then, the dispersion in the autoclave was heated to about 95° C. A microemulsion phase was formed. Then, the autoclave was brought to about 20 kg/cm² using a gaseous mixture, containing about 8% by moles of hexafluoropropylene (HFP) and 92% by moles of VF₂. Then, 3 gram of ammonium persulfate dissolved in 200 ml of de-ionized water was introduced to the autoclave. As soon as the pressure in the autoclave began to decrease, it was restored by feeding a gaseous HFP/VF₂ mixture containing about 8% by moles of HFP. The pressure inside the autoclave was kept at about 20 kg/cm² and temperature at about 95° C. for about 1 hour of reaction. The reaction was stopped by lowering the autoclave temperature to room temperature and the gas mixture was discharged. The dispersion was under vacuum at about 10 mm Hg for 15 minutes in order to have most 2H,3H-perfluoropentane and R-10 (CCl₄) removed from the dispersion product. Later, a translucent fluoropolymer nanoemulsion containing about 28% by weight of a fluoropolymeric resin was obtained. The fluoropolymer nanoemulsion was found to be colloidal stable, as little coagulant was found.

The average diameter of the fluoropolymer nano-particles was found to be about 50 to 90 nanometers by electron microscopy.

### Example 5

20 gram of the said fluoropolyether carboxylic acids with average acid number of 66 (mg of NaOH/g of acid) were neutralized by ammonia (30% in water) with some additional de-ionized water to make up 20% of the said fluoropolyether carboxylic acid ammonium solution in water. The entire surfactant solution was added to a 5-liter autoclave reactor equipped with a mechanical stirrer. Additional 2000 ml of de-ionized water was also added to the autoclave. The autoclave was then sealed and under vacuum to about 10 mm Hg. The autoclave was then filled with vinylidene fluoride (VF₂) to about 2 kg/cm² and then under vacuum again to about 10 mm Hg. The procedure was repeated until the oxygen content in the autoclave was less than 25 ppm.

While the autoclave was under vacuum, 10 gram of 1H,8H-perfluorooctane, a hydrofluorocarbon, was introduced into the autoclave. Then, the dispersion in the autoclave was heated to about 95° C. A microemulsion phase was formed. Then, the autoclave was brought to about 20 kg/cm² using a gaseous mixture, containing about 15% by moles of tetrafluoroethylene (TFE) and 85% by moles of VF₂. Then, 3 gram of ammonium persulfate dissolved in 200 ml of de-ionized water was introduced to the autoclave. As soon as the pressure in the autoclave began to decrease, it was restored by feeding a gaseous TFE/VF₂ mixture containing about 15% by moles of TFE. The pressure inside the autoclave was kept at about 20 kg/cm² and temperature at about 95° C. for about 1 hour of reaction. The reaction was stopped by lowering the autoclave temperature to room temperature and the gas mixture was discharged. The dispersion was under vacuum at about 10 mm Hg for 15 minutes in order to have most hydrofluorocarbon removed from the dispersion product. Later, a translucent fluoropolymer nanoemulsion containing about 33% by weight of a fluoropolymeric resin was obtained. The fluoropolymer nanoemulsion was found to be colloidal stable, as little coagulant was found.

The average diameter of the fluoropolymer nano-particles was found to be about 50 to 90 nanometers by electron microscopy.

We claim:

1. Fluoropolymer nanoemulsions comprising
(1) at least 20% by weight of colloidal fluoropolymer nano-particles with average diameter in the range of 1 to 150 nanometer,
(2) 0.1% to 3.0% by weight halogenated dispersing agents selected from fluoro surfactants, chlorofluoro surfactants, hydrofluoro surfactants, or hydrochlorofluoro surfactants, and
(3) 0.1% to 3.0% by weight of at least a CFC (chlorofluorocarbon) or a HFC (hydrofluorocarbon) or a HCFC (hydrochlorofluorocarbon) or a CC (chlorocarbon) with average molecular weight less than 500.

2. The CFC (chlorofluorocarbon) or a HFC (hydrofluorocarbon) or HCFC (hydrochlorofluorocarbon) or CC (chlorocarbon) of claim 1 are selected from R-10 (CCl₄), R-11 (CCl₃F), R-12 (CCl₂F₂), R-21 (CHCl₂F), R-31 (CH₂ClF), R-111 (CCl₃CCl₂F), R-112 (CCl₂FCCl₂F), R-112a (CCl₃CClF₂), R-113 (CCl₂FCClF₂), R-113a (CCl₃CF₃), R-114 (CClF₂CClF₂), R-114a (CF₃CFCl₂), R-121 (CCl₂FCHCl₂), R-121a (CHClFCCl₃), R-122 (CClF₂CHCl₂), R-122a (CHClFCCl₂F), R-123 (CF₃CHCl₂), R-123a (CClF₂CHClF), R-124 (CF₃CHClF), R-124a (CHF₂CFCl₂), R-131 (CHClFCHCl2), R-131a (CH₂ClCCl₂F), R-132 (CHClFCHClF), R-132a (CHCl₂CHF₂), R-132b (CH₂ClCClF₂), R-132c (CCl₂FCH₂F), R-133 (CHClFCHF₂), R-133a (CF₃CH₂Cl), R-133b (CClF₂CH₂F), R-141 (CHCl₂CHClF), R-141a (CHCl₂CH₂F), R-141b (CCl₂FCH₃), R-142 (CHF₂CH₂Cl), R-142a (CHClFCH₂F), R-142b (CClF₂CH₃), R-151 (CH₂FCH₂Cl), R-151a (CH₃CHClF), R-152 (CH₂FCH₂F), R-214cb (CCl₃CF₂CF₂Cl), R-215a (CF₃CCl₂CClF₂), R-216ba (CF₃CClFCF₂Cl), R-217ba (CF₃CFClCF₃), R-224db (CF₃CHClCCl₂F), R-225ba (CF₃CClFCHClF), R-225ca (CF₃CF₂CHCl₂), R-225cb (CF₂ClCF₂CHClF), R-225cc (CHF₂CF₂CFCl₂), R-225da (CF₃CHClCClF₂), R-226da (CF₃CHClCF₃), R-226ea (CF₃CHFCF₂Cl), R-234da (CF₃CHClCHClF), R-235ca (CF₃CF₂CH₂Cl), R-235fa (CF₃CH₂CF₂Cl), R-236ea (CF₃CHFCHF₂), R-243db (CF₃CHClCH₂Cl), R-244ca (CHF₂CF₂CH₂Cl), R-245ca (CHF₂CF₂CH₂F), R-245fa (CF₃CH₂CHF₂), R-254fb (CF₃CH₂CH₂F), R314 (1,1,2,2-tetrachlorotetrafluorocyclobutane), Trichlorohexafluorobutane, R3161bb (1,2,3,4-tetrachlorohexafluorobutane), R316maa (2,2,3,3-tetrachlorohexafluorobutane), R-317mab (CF₃CCl₂CClFCF₃), 1,1,1,3,3-Pentafluorobutane, Octafluorobutane, 1,2,2,2-Tetrafluoroethyl difluoromethyl ether, 3,3,4,4-Tetrafluorohydrofuran, 1,1,2,3,3,3-Hexafluoropropyl difluoromethyl ether, 1,1,2,3,3,3-Hexafluoropropyl trichloromethyl ether, 1,1,2,3,3,3-Hexafluoropropyl 2,2,2-trifluoroethyl ether, 1H,1H,2H-Heptafluorocyclopentane, 1H,2H-Octafluorocyclopentane, 2H,3H-Perfluoropentane, Nonafluoropentane, 1,1,3,5,6-Pentachloroperfluorohexane, 1H-Perfluorohexane, 1H,6H-Dodecafluorohexane, 1H-Perfluoroheptane, 1H,1H,5H-Octafluoropentyl 1,1,2,2-tetrafluoroethyl ether, 1H,8H-Perfluorooctane, 1H-Perfluorooctane, 1H,1H,2′H-Perfluorodipropyl ether, 1-Chloro-2,2,2-trifluoroethyl difluoromethyl ether, 2,2,2-Trifluoroethyl trifluoroacetate.

3. The dispersing agents of claim 1 are selected from perfluoroalkyl ethane sulfonic acids and salts, perfluoroalkoxy benzene sulfonic acids and salts, partially-fluorinated carboxylic acids and salts, fluoropolyether carboxylic acids and salts, chlorofluoropolyether carboxylic acids and salts, hydrofluoropolyether carboxylic acids and salts, or hydrochlorofluoropolyether carboxylic acids and salts.

4. The fluoropolyether carboxylic acids and salts, chlorofluoropolyether carboxylic acids and salts, hydrofluoropolyether carboxylic acids and salts, or hydrochlorofluoropolyether carboxylic acids and salts of claim 3 have average molecular weight between 200 and 1800 and each molecule has one or two carboxylic acid groups.

5. The fluoropolymer of claim 1 includes polytetrafluoroethylene (PTFE), Modified PTFE, polychlorotrifluoroethylene (PCTFE), polyvinyl fluoride (PVF), polyvinylidene fluoride (PVDF), and copolymers of two or multiple monomers capable of being copolymerized selected from tetrafluoroethylene (TFE), vinyl fluoride (VF), vinylidene fluoride (VF₂), trifluoroethylene, hexafluoropropylene (HFP), chlorotrifluoroethylene (CTFE), fluoro(alkyl vinyl ether), such as perfluoro(propyl vinyl ether), perfluoro(ethyl vinyl ether), and perfluoro(methyl vinyl ether), fluoro(alkoxy vinyl ether), fluoroalkyl ethylene, fluoroalkoxy ethylene, fluoroalkyl acrylates, fluoroalkyl methacrylates, and optionally hydrogenated monomers, including ethylene, propylene, isobutylene, butylenes, and optionally minor amount of cure site monomers including bromofluoroalkoxyethylene, bromotetrafluorobutene, CF₂═CF[OCF₂CFCF₃]ₘ—O—(CF₂)ₙ—CH₂OH, CF₂═CF[OCF₂CFCF₃]ₘ—O—(CF₂)ₙ—CH₂COOH, and others containing different functional end group such as —SO₂F, —CN, —OCN, —O—(CO)—NH₂ or —OP(O)(OH)₂.

6. The colloidal fluoropolymer nano-particles of claim 1 have average diameter between 1 and 130 nanometers.

7. The colloidal fluoropolymer nano-particles of claim 1 have average diameter between 10 and 100 nanometers.

8. Fluoropolymer nanoemulsions, comprising
(1) at least 20% by weight of colloidal fluoropolymer nano-particles with average diameter in the range of 1 to 150 nanometer,
(2) 0.1% to 3.0% by weight of halogenated dispersing agents selected from fluoro surfactants, chlorofluoro surfactants, hydrofluoro surfactants, or hydrochlorofluoro surfactants, and
(3) any CFC (chlorofluorocarbon) or any HFC (hydrofluorocarbon) or any HCFC (hydrochlorofluorocarbon) or any CC (chlorocarbon) having been partially or mostly removed from the nanoemulsion to be less than 0.5% by weight of the nanoemulsion.

9. The CFC (chlorofluorocarbon) or HFC (hydrofluorocarbon) or HCFC (hydrochlorofluorocarbon) or CC (chlorocarbon) of claim 8 are selected from R-10 (CCl₄), R-11 (CCl₃F), R-12 (CCl₂F₂), R-21 (CHCl₂F), R-31 (CH₂ClF), R-111 (CCl₃CCl₂F), R-112 (CCl₂FCCl₂F), R-112a (CCl₃CClF₂), R-113 (CCl₂FCClF₂), R-113a (CCl₃CF₃), R-114 (CClF₂CClF₂), R-114a (CF₃CFCl₂), R-121 (CCl₂FCHCl₂), R-121a (CHClFCCl₃), R-122 (CClF₂CHCl₂), R-122a (CHClFCCl₂F), R-123 (CF₃CHCl₂), R-123a (CClF₂CHClF), R-124 (CF₃CHClF), R-124a (CHF₂CFCl₂), R-131 (CHClFCHCl2), R-131a (CH₂ClCCl₂F), R-132 (CHClFCHClF), R-132a (CHCl₂CHF₂), R-132b (CH₂ClCClF₂), R-132c (CCl₂FCH₂F), R-133 (CHClFCHF₂), R-133a (CF₃CH₂Cl), R-133b (CClF₂CH₂F), R-141 (CHCl₂CHClF), R-141a (CHCl₂CH₂F), R-141b (CCl₂FCH₃), R-142 (CHF₂CH₂Cl), R-142a (CHClFCH₂F), R-142b (CClF₂CH₃), R-151 (CH₂FCH₂Cl), R-151a (CH₃CHClF), R-152 (CH₂FCH₂F), R-214cb (CCl₃CF₂CF₂Cl), R-215a (CF₃CCl₂CClF₂), R-216ba (CF₃CClFCF₂Cl), R-217ba (CF₃CFClCF₃), R-224db (CF₃CHClCCl₂F), R-225ba (CF₃CClFCHClF), R-225ca (CF₃CF₂CHCl₂), R-225cb (CF₂ClCF₂CHClF), R-225cc (CHF₂CF₂CFCl₂), R-225da (CF₃CHClCClF₂), R-226da (CF₃CHClCF₃), R-226ea (CF₃CHFCF₂Cl), R-234da (CF₃CHClCHClF), R-235ca (CF₃CF₂CH₂Cl), R-235fa (CF₃CH₂CF₂Cl), R-236ea (CF₃CHFCHF₂), R-243db (CF₃CHClCH₂Cl), R-244ca (CHF₂CF₂CH₂Cl), R-245ca (CHF₂CF₂CH₂F), R-245fa (CF₃CH₂CHF₂), R-254fb (CF₃CH₂CH₂F), R314 (1,1,2,2-tetrachlorotetrafluorocyclobutane), Trichlorohexafluorobutane, R3161bb (1,2,3,4-tetrachlorohexafluorobutane), R316maa (2,2,3,3-tetrachlorohexafluorobutane), R-317mab (CF₃CCl₂CClFCF₃), 1,1,1,3,3-Pentafluorobutane, Octafluorobutane, 1,2,2,2-Tetrafluoroethyl difluoromethyl ether, 3,3,4,4-Tetrafluorohydrofuran, 1,1,2,3,3,3-Hexafluoropropyl difluoromethyl ether, 1,1,2,3,3,3-Hexafluoropropyl trichloromethyl ether, 1,1,2,3,3,3-Hexafluoropropyl 2,2,2-trifluoroethyl ether, 1H,1H,2H-Heptafluorocyclopentane, 1H,2H-Octafluorocyclopentane, 2H,3H-Perfluoropentane, Nonafluoropentane, 1,1,3,5,6-Pentachloroperfluorohexane, 1H-Perfluorohexane, 1H,6H-Dodecafluorohexane, 1H-Perfluoroheptane, 1H,1H,5H-Octafluoropentyl 1,1,2,2-tetrafluoroethyl ether, 1H,8H-Perfluorooctane, 1H-Perfluorooctane, 1H,1H,2′H-Perfluorodipropyl ether, 1-Chloro-2,2,2-trifluoroethyl difluoromethyl ether, 2,2,2-Trifluoroethyl trifluoroacetate

10. The dispersing agents of claim 8 are selected from perfluoroalkyl ethane sulfonic acids and salts, perfluoroalkoxy benzene sulfonic acids and salts, partially-fluorinated carboxylic acids and salts, fluoropolyether carboxylic acids and salts, chlorofluoropolyether carboxylic acids and salts, hydrofluoropolyether carboxylic acids and salts, or hydrochlorofluoropolyether carboxylic acids and salts.

11. The fluoropolyether carboxylic acids and salts, chlorofluoropolyether carboxylic acids and salts, hydrofluoropolyether carboxylic acids and salts, or hydrochlorofluoropolyether carboxylic acids and salts of claim 10 have average molecular weight between 200 and 1800 and each molecule has one or two carboxylic acid groups.

12. The fluoropolymer of claim 8 includes polytetrafluoroethylene (PTFE), Modified PTFE, polychlorotrifluoroethylene (PCTFE), polyvinyl fluoride (PVF), polyvinylidene fluoride (PVDF), and copolymers of two or multiple monomers capable of being copolymerized selected from tetrafluoroethylene (TFE), vinyl fluoride (VF), vinylidene fluoride (VF₂), trifluoroethylene, hexafluoropropylene (HFP), chlorotrifluoroethylene (CTFE), fluoro(alkyl vinyl ether), such as perfluoro(propyl vinyl ether), perfluoro(ethyl vinyl ether), and perfluoro(methyl vinyl ether), fluoro(alkoxy vinyl ether), fluoroalkyl ethylene, fluoroalkoxy ethylene, fluoroalkyl acrylates, fluoroalkyl methacrylates, and optionally hydrogenated monomers, including ethylene, propylene, isobutylene, butylenes, and optionally minor amount of cure site monomers including bromofluoroalkoxyethylene, bromotetrafluorobutene, CF₂═CF[OCF₂CFCF₃]ₘ—O—(CF₂)ₙ—CH₂OH, CF₂═CF[OCF₂CFCF₃]ₘ—O—(CF₂)ₙ—CH₂COOH, and others containing different functional end group such as —SO₂F, —CN, —OCN, —O—(CO)—NH₂ or —OP(O)(OH)₂.

13. The colloidal fluoropolymer nano-particles of claim 8 have average diameter between 1 and 130 nanometers.

14. The colloidal fluoropolymer nano-particles of claim 8 have average diameter between 10 and 100 nanometers.

15. A process for making fluoropolymer nanoemulsions, wherein colloidal nano-particles have average diameter between and 1 and 150 nanometers and solid content greater than 20 weight %, comprising polymerizing at least one fluorinated monomer in an aqueous medium containing initiator and dispersing agent, characterized in that it is operated in the presence of at least a CFC (chlorofluorocarbon) or a HFC (hydrofluorocarbon), or a HCFC (hydrochlorofluorocarbon) or a CC (chlorocarbon) with average molecular weight less than 500, wherein at least a microemulsion phase is present.

16. The process of claim 15 wherein the said CFC (chlorofluorocarbon) or HFC (hydrofluorocarbon) or a HCFC (hydrochlorofluorocarbon) or a CC (chlorocarbon) is partially or mostly removed from the resulting fluoropolymer nanoemulsions after polymerization by a separation process.

17. The process of claim 16 wherein the separation process include distillation or vacuum distillation or extraction.

18. Fluorinated monomer of claim 15 is capable of being radical polymerized or copolymerized and contain at least 35 weight % fluorine and have 2-18 carbon atoms, selected from tetrafluoroethylene (TFE), vinyl fluoride, vinylidene fluoride (VF₂), trifluoroethylene, hexafluoropropylene (HFP), chlorotrifluoroethylene (CTFE), fluoro(alkyl vinyl ether), such as perfluoro(propyl vinyl ether), perfluoro(ethyl vinyl ether), and perfluoro(methyl vinyl ether), fluoro(alkoxy vinyl ether), fluoroalkyl ethylene, fluoroalkoxy ethylene, fluoroalkyl acrylates, fluoroalkyl methacrylates, and minor amount of bromofluoroalkoxyethylene, bromotetrafluorobutene, CF₂═CF[OCF₂CFCF₃]ₘ—O—(CF₂)ₙ—CH₂OH, CF₂═CF[OCF₂CFCF₃]ₘ—O—(CF₂)ₙ—CH₂COOH, and other cure site monomers including fluoro vinyl ether monomers containing different functional end group such as —SO₂F, —CN, —OCN, —O—(CO)—NH₂ or —OP(O)(OH)₂.

19. The CFC (chlorofluorocarbon) or HFC (hydrofluorocarbon) or HCFC (hydrochlorofluorocarbon) or CC (chlorocarbon) of claim 15 are selected from R-10 (CCl₄), R-11 (CCl₃F), R-12 (CCl₂F₂), R-21 (CHCl₂F), R-31 (CH₂ClF), R-111 (CCl₃CCl₂F), R-112 (CCl₂FCCl₂F), R-112a (CCl₃CClF₂), R-113 (CCl₂FCClF₂), R-113a (CCl₃CF₃), R-114 (CClF₂CClF₂), R-114a (CF₃CFCl₂), R-121 (CCl₂FCHCl₂), R-121a (CHClFCCl₃), R-122 (CClF₂CHCl₂), R-122a (CHClFCCl₂F), R-123 (CF₃CHCl₂), R-123a (CClF₂CHClF), R-124 (CF₃CHClF), R-124a (CHF₂CFCl₂), R-131 (CHClFCHCl2), R-131a (CH₂ClCCl₂F), R-132 (CHClFCHClF), R-132a (CHCl₂CHF₂), R-132b (CH₂ClCClF₂), R-132c (CCl₂FCH₂F), R-133 (CHClFCHF₂), R-133a (CF₃CH₂Cl), R-133b (CClF₂CH₂F), R-141 (CHCl₂CHClF), R-141a (CHCl₂CH₂F), R-141b (CCl₂FCH₃), R-142 (CHF₂CH₂Cl), R-142a (CHClFCH₂F), R-142b (CClF₂CH₃), R-151 (CH₂FCH₂Cl), R-151a (CH₃CHClF), R-152 (CH₂FCH₂F), R-214cb (CCl₃CF₂CF₂Cl), R-215a (CF₃CCl₂CClF₂), R-216ba (CF₃CClFCF₂Cl), R-217ba (CF₃CFClCF₃), R-224db (CF₃CHClCCl₂F), R-225ba (CF₃CClFCHClF), R-225ca (CF₃CF₂CHCl₂), R-225cb (CF₂ClCF₂CHClF), R-225cc (CHF₂CF₂CFCl₂), R-225da (CF₃CHClCClF₂), R-226da (CF₃CHClCF₃), R-226ea (CF₃CHFCF₂Cl), R-234da (CF₃CHClCHClF), R-235ca (CF₃CF₂CH₂Cl), R-235fa (CF₃CH₂CF₂Cl), R-236ea (CF₃CHFCHF₂), R-243db (CF₃CHClCH₂Cl), R-244ca (CHF₂CF₂CH₂Cl), R-245ca (CHF₂CF₂CH₂F), R-245fa (CF₃CH₂CHF₂), R-254fb (CF₃CH₂CH₂F), R314 (1,1,2,2-tetrachlorotetrafluorocyclobutane), Trichlorohexafluorobutane, R3161bb (1,2,3,4-tetrachlorohexafluorobutane), R316maa (2,2,3,3-tetrachlorohexafluorobutane), R-317mab (CF₃CCl₂CClFCF₃), 1,1,1,3,3-Pentafluorobutane, Octafluorobutane, 1,2,2,2-Tetrafluoroethyl difluoromethyl ether, 3,3,4,4-Tetrafluorohydrofuran, 1,1,2,3,3,3-Hexafluoropropyl difluoromethyl ether, 1,1,2,3,3,3-Hexafluoropropyl trichloromethyl ether, 1,1,2,3,3,3-Hexafluoropropyl 2,2,2-trifluoroethyl ether, 1H,1H,2H-Heptafluorocyclopentane, 1H,2H-Octafluorocyclopentane, 2H,3H-Perfluoropentane, Nonafluoropentane, 1,1,3,5,6-Pentachloroperfluorohexane, 1H-Perfluorohexane, 1H,6H-Dodecafluorohexane, 1H-Perfluoroheptane, 1H,1H,5H-Octafluoropentyl 1,1,2,2-tetrafluoroethyl ether, 1H,8H-Perfluorooctane, 1H-Perfluorooctane, 1H,1H,2′H-Perfluorodipropyl ether, 1-Chloro-2,2,2-trifluoroethyl difluoromethyl ether, 2,2,2-Trifluoroethyl trifluoroacetate

20. The dispersing agents of claim 15 are selected from perfluoroalkyl ethane sulfonic acids and salts, perfluoroalkoxy benzene sulfonic acids and salts, partially-fluorinated carboxylic acids and salts, fluoropolyether carboxylic acids and salts, chlorofluoropolyether carboxylic acids and salts, hydrofluoropolyether carboxylic acids and salts, or hydrochlorofluoropolyether carboxylic acids and salts.
